(19) United States
(12) Patent Application Publication
(10) Pub. No.: US 2003/0121615 A1
(43) Pub. Date: Jul. 3, 2003

(54) Apparatus and method for applying labeling

(75) Inventors: David Gravelle, Bradford (CA); Tim McNamee, Toronto (CA); Gregory L. Bartle, Stouffville (CA)

Correspondence Address: James G. Porcelli, WEBB ZIESENHEIM LOGSDON ORKIN & HANSON, P.C., 700 Koppers Building, 436 Seventh Avenue, Pittsburgh, PA, 15219-1818, US

(73) Assignee: AHEARN & SOPER INC, Rexdale (CA)

(21) Appl. No.: 10/273,387

(22) Filed: Oct. 17, 2002

Related U.S. Application Data
(60) Provisional application No. 60/329,523, filed on Oct. 17, 2001.

(30) Foreign Application Priority Data
Oct. 17, 2001 (CA) 2,359,369

(51) Int. Cl. B32B 31/00

(52) U.S. Cl. 156/556

(57) ABSTRACT

An apparatus and method for applying labels and laminates comprises an applicator for applying a printed label and a laminate. The printed label corresponds to the article to be labeled and the laminate is sized to cover the printed label. The applicator applies the printed label and the laminate in sequence to the same location on the article to be labeled.

### FIELD OF INVENTION

This invention relates to labeling and in particular to an apparatus and method to apply labeling.

### BACKGROUND OF THE INVENTION

In certain manufacturing systems, it is necessary to label each article as it is being manufactured. For example, in the manufacture of cars, an assembly plant starts with car frames. It is advantageous to label the car frames in order to track and identify each car during manufacture so that a manufacturing system could customize a particular car with optional equipment as required.

However, the environment for the manufacture of cars is very harsh, which creates an unique set of problems. For example, the assembly plant receives the car frames in a bare metal state covered with an oil film. A label is attached each car frame before the manufacturing step in which the car frames are painted. Thus, a specification for labeling of car frames, for example, requires each label to accept a thermal transfer barcode, adhere to an oil covered unpainted metal surface, go through a paint cycle with 360 degrees F. heat temperatures for 30 minutes multiple times and, at the end, the barcode on the label must still be readable without any paint adhering to the label.

The label also has to survive a cleaning tank with heavy power wash sprays and has to remain on the car frames for a long period of time after the painting. In addition, the oil film usually holds other contaminants such as dust. The car frames may also have rust spots, such as, from welding.

The unique set of problems includes providing a covering or laminate to protect the printing on the labels from the manufacturing environment, printing of the labels on-demand rather than in batch mode, and applying the laminates to cover over the labels within very narrow tolerances.

There are a number of methods of applying labels to the car frames. Firstly, there is the manual or hand method where a spot on a car frame is first cleaned by hand, then a label is applied by hand, followed by a cover (such as masking tape) which is also applied by hand. The masking cover is removed after the painting processes. This method has a number of problems including the removal of printing when the masking cover is removed and the lack of consistent alignment between the masking cover and the label.

Another method prints the labels and a laminate is applied over top of the labels. This process is done in batch mode. However, this method does not have the print on demand capabilities required by some manufacturing systems. The clear laminate has a dual layer (two layers) so that the first layer may be removed without removing any printing while leaving the second layer to protect the label in subsequent manufacturing processes after the painting.

In yet a further method, a label is applied to a car frame in three steps under computer control. First, an automatic cleaning station cleans a spot on the car frame. Second, the car frame is then moved to an automatic label applicator where the label is printed and applied on the spot. Third, the car frame is then moved to an automatic laminate applicator where a laminate is applied over the label. This method, however, could not accurately place the laminate over the label. It is also costly to implement due to the number of stations. It is also inefficient due to the manufacturing time required for the car frames at each of the stations.

It is therefore desirable to provide apparatus and method to applying labeling, which addresses, some of the shortcomings of providing labeling noted above.

### SUMMARY OF THE INVENTION

According to an aspect of the invention, there is provided an apparatus for applying labels and laminates comprising:

a labeler for providing a printed label;

a laminator for providing a laminate, said laminate being sized to cover said printed label; and

an applicator for applying said printed label and said laminate to an article to be labeled;

wherein said applicator applies said printed label and said laminate in sequence to the same location on said article to be labeled.

According to another aspect of the present invention there is provided a method for applying labels and laminates comprising:

providing a printed label;

applying said printed label to an article to be labeled;

providing a laminate sized to cover said printed label; and

applying said laminate over said printed label;

wherein said printed label and said laminate are applied in sequence and said laminate covers said printed label.

The present invention provides an advantage in that a single automatic applicator is used rather two applicators. This overcomes the problem of accurate label/laminate placement and reduces the number of stations or steps required.

The present invention provides a further advantage in that the labels and laminates can be very accurately placed on the single applicator and thus the laminates can be very accurately place on the labels.

The present invention provides yet a further advantage in that an adhesive for adhering to oily metals and rough surfaces is used for applying the labels to the car frames, thus a cleaning station or step is also eliminated.

### BRIEF DESCRIPTION OF THE DRAWINGS

The present invention will be described in detail with reference to the accompanying drawings, in which like numerals denote like parts, and in which

FIG. 1 is a block diagram of an automatic labeling system with an apparatus in accordance with one embodiment of the invention;

FIG. 2 is a top plan view in more detail of the apparatus of FIG. 1; and

FIG. 3 is a flowchart of the application process flow for the label-laminator of FIG. 2.

### DETAILED DESCRIPTION OF THE PREFERRED EMBODIMENTS

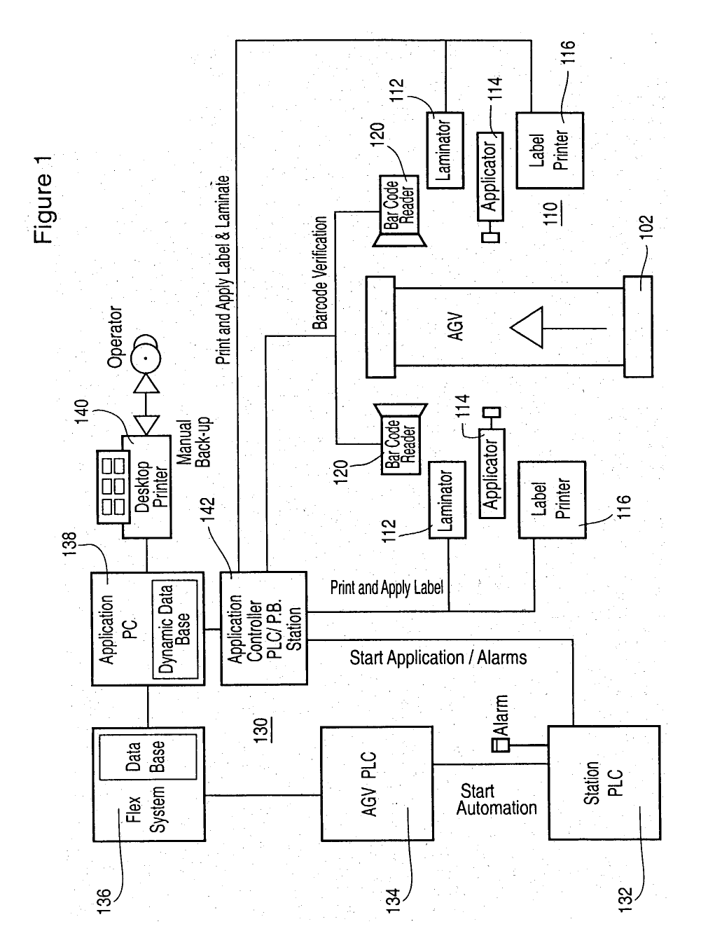

Referring to FIG. 1, there is shown a block diagram of an automatic labeling system 100 with an apparatus 110 in accordance with one embodiment of the invention. The automatic labeling system 100 comprises an AGV (Automatic Guided Vehicle) 102 for moving a car frame into position for labeling; the apparatus 110 comprises a laminator 112, an applicator 114, and a labeler and printer 116, for printing and applying labels, and applying laminates; bar code reader 120 for verifying that the correct labels have been applied and that the applied labels are readable; and computers 130 comprising a station PLC (Programmable Logic Controller) 132, a AGV PLC 134, a flex system 136, an application PC 138, and an application controller 142. The computers 130 control the system 100 including providing information specific to a car frame for printing on the labels. In this system 100, a label is applied to opposite sides of car frames. A desktop printer 140 is provided as a backup.

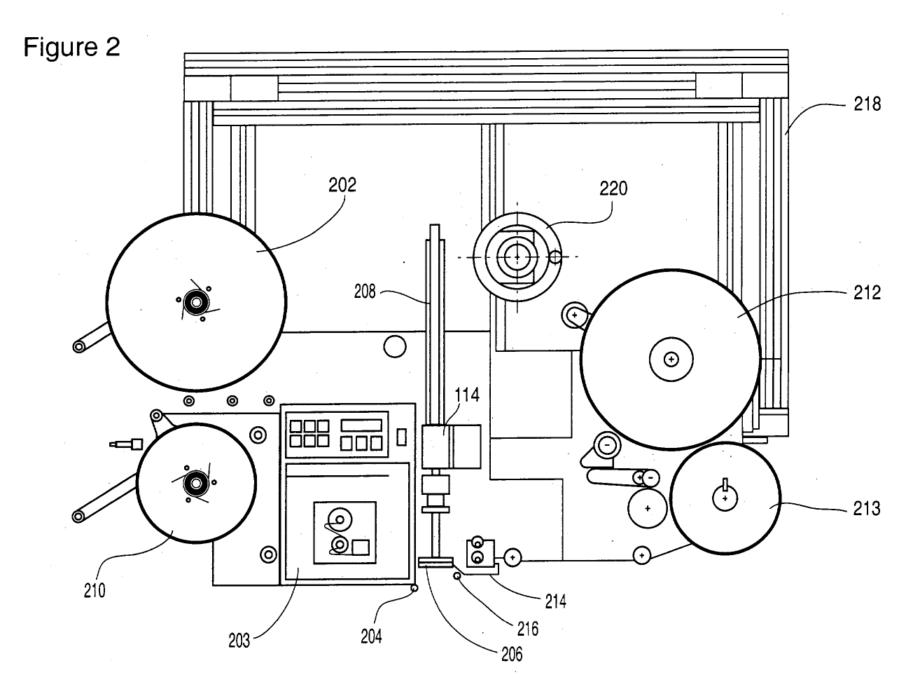

Referring to FIG. 2, there is shown a top plan view in more detail of the apparatus 110 of FIG. 1. The apparatus 110 comprises a label supply disk 202, a label printer 203, an air assist 204, the applicator 114 comprising a tamp head 206 and a thruster 208, a label waste rewind disk 210, a laminate supply disk 212, a laminate waste rewind disk 213, a laminator peel bar 214, a second air assist 216, a frame 218, and a height adjuster 220. The label supply disk 202 holds a label supply web with the labels. The labels are attached by a first adhesive to the label supply web. The label printer 203 prints information specific to each car frame onto the labels and peels the labels from the label supply web for placement onto the tamp head 206 of the applicator 114 with the assistance of the air assist 204 (stream of air). The tamp head 206 receives the labels, one label at a time, from the label supply web and the label is held against the tamp head 206 by a pneumatic device which operates as a vacuum. The thruster 208 extends the tamp head 206 to the car frame for attachment of the label, where the pneumatic device switches off the vacuum and turns on a blower, which provides air pressure to press the label against the car frame. The thruster 208 then retracts the tamp head 206 to receive the laminate. The label waste rewind disk 210 receives the label supply web after the labels have been removed.

The laminate supply disk 212 holds a laminate supply web with the laminates (cut into the same dimensions as the labels) attached by a second adhesive to the laminate supply web. As the laminate supply web passes the laminator peel bar 214, the laminates are peeled from the laminate supply web. The second air assist 216 assists in placing each laminate, one laminate at a time, onto the tamp head 206. The laminate is held against the tamp head 206 with a vacuum. The thruster 208 then extends the tamp head 206 to the car frame for attachment of the laminate over the label, where the vacuum is turned off and the air blower turned on to press the laminate against the car frame. The thruster 208 then retracts the tamp head 206 to receive a next label for a next car frame. The laminate waste rewind disk 210 receives the laminate supply web after the laminates have been removed.

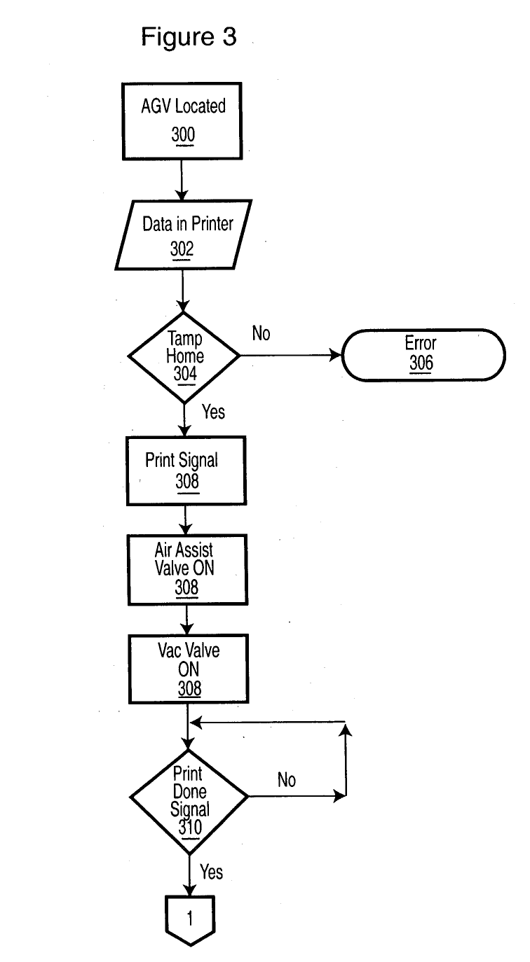

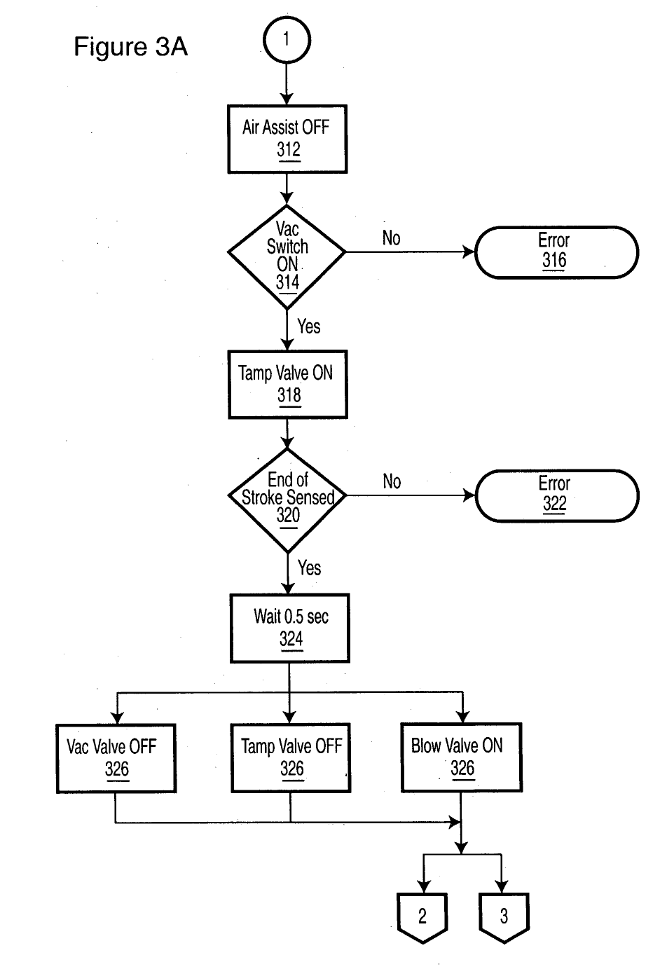

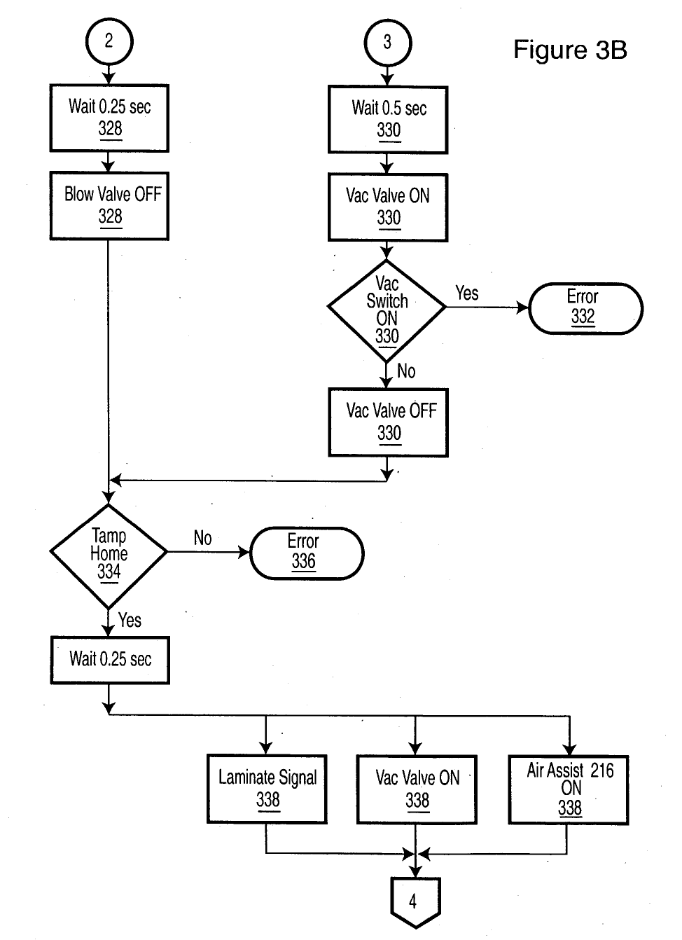

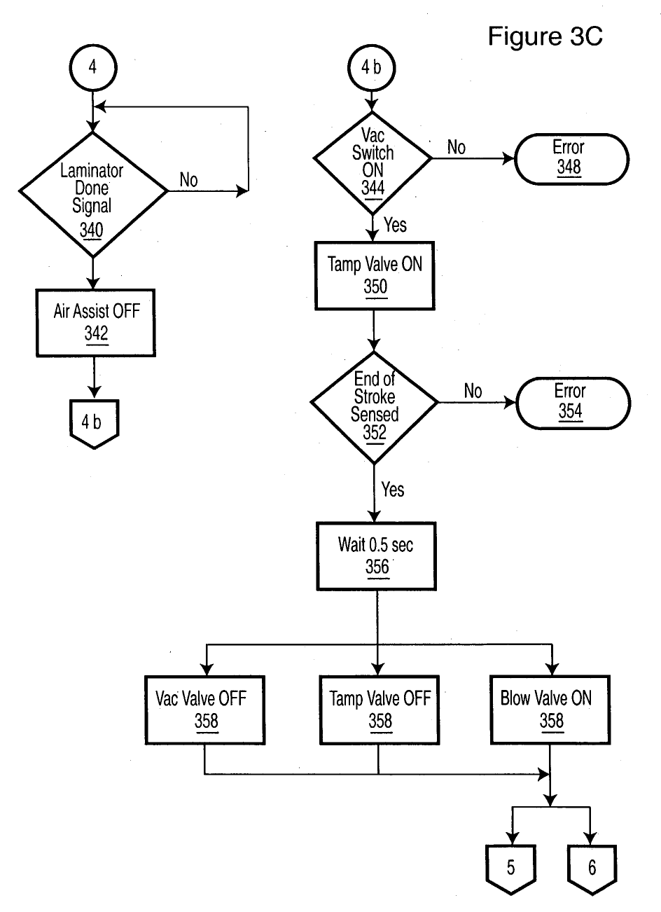

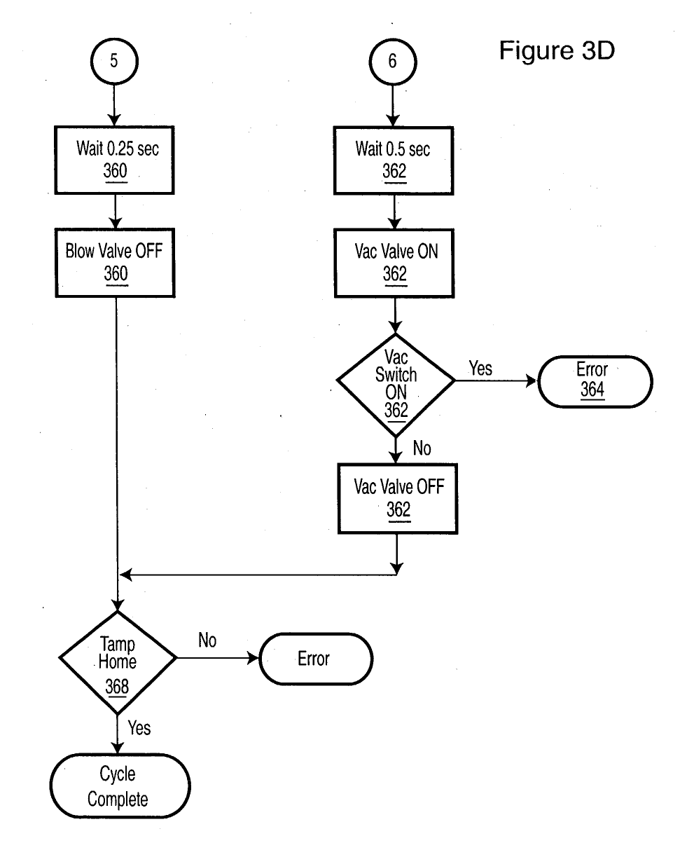

Referring to FIG. 3, there is shown a flowchart a label-laminator application process flow of FIG. 2. At step 300, the movement of the car frame by the AGV into position for labeling is detected. At step 302, data in respect of the car frame is transferred to the label printer 116. At step 304, the tamp head 206 is verified to be in a receiving position. If the tamp head 206 is not in position then an error recovery sequence 306 in initiated. At step 308, the label printer 116 is signaled to print the label, and the air assist 204 and a vacuum switch turned on for the vacuum at the tamp head 206 to receive the printed label. When the label has been printed and placed on the tamp head 206 (step 310), the air assist 204 is turned off (step 312). At step 314, a vacuum detect switch (not shown) is used to verify that there is a vacuum detected at the tamp head 206 to indicate proper receipt of the label. If there is no vacuum detected then an error recovery sequence (step 316) is initiated.

At step 318, a tamp valve is turned on for the thruster 208 to extend the tamp head 206 against the car frame. At step 320, the sensing of the end of stroke of the thruster 208 indicates that the tamp head 206 is against the car frame. If the end of stroke is not detected then an error recovery sequence (step 322) is initiated. The label is held by the tamp head 206 against the car frame for 0.5 seconds (step 324) so that the first adhesive adheres the label to the car frame.

At step 326, the tamp valve is turned off to retract the thruster 208 and therefore the tamp head 206, the vacuum switch is turned off to release the vacuum, and a blow valve turned on to blow the label off the tamp head 206. At step 328, the blow valve is turned off after 0.25 seconds. At step 330, after waiting 0.5 second, the vacuum valve is again turned on until the vacuum is detected, which indicates that the label is no longer on the tamp head 206. If no vacuum is detected then an error recovery sequence (step 332) is initiated. At step 334, the tamp head 206 is verified to have returned to the receiving position. If not, then an error recovery sequence (step 336) is initiated.

At step 338, the laminator 112 is signaled to send out the laminate, the vacuum valve turned on for the vacuum at the tamp head 206, and the air assist 216 turned on to assist with the placement of the laminate on the tamp head 206. When the laminate has been placed on the tamp head 206 (step 340), the air assist 216 is turned off (step 342). At step 344, a vacuum detect switch (not shown) is used to verify that there is a vacuum detected at the tamp head 206 to indicate proper receipt of the laminate. If there is no vacuum detected then an error recovery sequence (step 348) is initiated.

At step 350, the tamp valve is turned on for the thruster 208 to extend the tamp head 206 against the car frame. At step 352, the sensing of the end of stroke of the thruster 208 indicates that the tamp head 206 is against the car frame. If the end of stroke is not detected then an error recovery sequence (step 354) is initiated. The laminate is held by the tamp head 206 against the car frame for 0.5 seconds (step 356) so that the second adhesive adheres the laminate to the label on the car frame.

At step 358, the tamp valve is turned off to retract the thruster 208 and therefore the tamp head 206, the vacuum switch is turned off to release the vacuum, and a blow valve turned on to blow the laminate off the tamp head 206. At step 360, the blow valve is turned off after 0.25 seconds. At step 362, after waiting 0.5 second, the vacuum valve is again turned on until the vacuum is detected, which indicates that the laminate is no longer on the tamp head 206. If no vacuum is detected then an error recovery sequence (step 364) is initiated. At step 368, the tamp head 206 is verified to have returned to the receiving position and completing a cycle. If not, then an error recovery sequence (step 336) is initiated.

Without limiting the scope of the present invention, the following examples are provided.

For this application, a polyester label with an acrylic adhesive was used. The labels used are called White Polyester/Permanent Acrylic Adhesive/Kraft Liner (a generic brand name). The preferred label product is from 3M Canada, Product Code: 7871, 2.0 mil Gloss Radiant Topcoated White Polyester/350 Acrylic Adhesive/55# Liner. Other possible label products are: Flexcon Product Code: 21940, 2 mil Topcoated White Polyester/L-344 Acrylic Adhesive/50 Kraft Liner; JAC Canada Product Code: R-P0381-Q515, 3mil Matte White Thermalux/E127 Acrylic Adhesive/50# Kraft Liner; Fasson Canada Product Code: Special, White Polyolefin Thermal Transfer-Printable Film/Hot Melt Rubber Adhesive/40#; Fasson Canada Product Code: 82737, 2.0 mil White Printable Polyester/S730 Solvent Acrylic Adhesive/50# Kraft Liner.

The acrylic adhesive from these manufacturers has been formulated for adhering to oily metals, rough surfaces, and low surface energy materials. These adhesives are generally coated out of solvent and are based on acrylic polymers.

For this application, the laminates are generally called Dual Polyester Laminate with Patterned Adhesive and Tinted Top Laminate. The preferred laminate product is: Flexcon, Piggyback OM100 Clear V-58 150 Poly H-9 V-344 42 White PP-8 Zone, Coat/Q-8. Other laminate products are: Imtec, Paint Block Dual Laminate; Flexcon, Piggyback OM100 Clear V-302LP Zone Coat OM100 Clear V-344 100 Poly H-9R; Flexcon, Piggyback OM100 Clear V-302LP 150 Poly V-344 42 White PP-8 Zone Coat.

Further, there were problems with the gumming up of the labels on the applicator. A varnish (Q-8) on the back of the liner of the labels is applied to avoid this back lifting of the adhesive.

For this application, a yellow tint is added to the first layer of the laminates in order to indicate when the first layer has been removed. The Yellow Tint used on the Laminates is from F. H. & Sons Manufacturing Ltd., GP-00/MP General Purpose Inks.

For this application, the facestock of the labels had to be polyester to withstand the high temperatures and the life of the labels required on the vehicles. The adhesive is an acrylic base adhesive for the long-aging properties. Rubber based adhesives breakdown over time and leave adhesive transfer if removed.

For this application, a two-layer laminate is used. The second (bottom) layer of the laminate had to permanently adhere to the label. The first (top) layer of laminate had to securely adhere to the bottom layer through the wash spray, paint and heat processes, but in the end be cleanly removable to reveal the clean bottom laminate and the bar code printed on the label. The dual polyester laminate is patterned with an adhesive coated on the back top layer of the dual laminate to allow easy removal of the top layer at the end of the process.

For this application, an adhesive pattern (with a dead zone—no adhesive) is used between the first and the second layers to allow for easy removal of the first layer. To avoid the top layer of the laminate coming off a spray wash, the labels are positioned with the dead zone of the adhesive at the bottom.

Although preferred embodiments of the invention have been described herein, it will be understood by those skilled in the art that variations may be made thereto without departing from the scope of the invention.

We claim:

1. An apparatus for applying labels and laminates comprising:
a labeler for providing a printed label;
a laminator for providing a laminate, said laminate being sized to cover said printed label; and
an applicator for applying said printed label and said laminate to an article to be labeled;
wherein said applicator applies said printed label and said laminate in sequence to the same location on said article to be labeled.

2. An apparatus as claimed in claim 1, wherein said applicator comprises a thruster and a head, said head being actuable by said thruster to move into and out of contact with said article to be labeled.

3. An apparatus as claimed in claim 2, wherein said applicator includes a pneumatic device operable to allow said head to receive one of said printed label and said laminate.

4. An apparatus as claimed in claim 3, wherein said pneumatic device is further operable as a blower to uncouple one of said printed label and said laminate from said head following application of said printed label and said laminate to said article to be labeled.

5. An apparatus as claimed in claim 1, wherein said applicator is actuated by the detection of said article to be labeled moving into a pre-determined labeling position.

6. An apparatus as claimed in claim 1, wherein said labeler comprises a label supply web mounted on a spool, said label supply web carrying a supply of printed labels in sequence.

7. An apparatus as claimed in claim 6, wherein said labeler further comprises an air assist for transferring said printed labels to a head of said applicator.

8. An apparatus as claimed in claim 1, wherein said printed label supplied by said labeler is customized to include information specific to said article to be labeled.

9. An apparatus as claimed in claim 1, wherein said laminator comprises a laminator supply web mounted on a spool, said laminator supply web carrying a supply of laminates in sequence.

10. An apparatus as claimed in claim 9, wherein said laminator further comprises an air assist for transferring said laminates to a head of said applicator.

11. An apparatus as claimed in claim 1, wherein said article to be labeled is a component of a product being manufactured on an assembly line.

12. An apparatus as claimed in claim 1, wherein said printed label includes an adhesive layer for adhering to said article to be labeled.

13. An apparatus as claimed in claim 12, wherein said adhesive layer is capable of adhering to oily metals and rough surfaces.

14. An apparatus as claimed in claim 1, wherein said article to be labeled is a frame of a vehicle being manufactured on an assembly line.

15. A method for applying labels and laminates comprising:
providing a printed label;
applying said printed label to an article to be labeled;
providing a laminate sized to cover said printed label; and
applying said laminate over said printed label;
wherein said printed label and said laminate are applied by a common applicator in sequence and said laminate covers said printed label.

16. A method as claimed in claim 15, further comprising printing said printed label.

17. A method as claimed in claim 16, wherein said printed label is customized to include information specific to said article to be labeled.

18. A method as claimed in claim 15, wherein said article to be labeled is a component of a product being manufactured on an assembly line.

19. A method as claimed in claim 15, wherein said article to be labeled is a frame of a vehicle being manufactured on an assembly line.
